(19) United States
(12) Patent Application Publication
(10) Pub. No.: US 2004/0246603 A1
(43) Pub. Date: Dec. 9, 2004

(54) Method for achieving a mirror surface and mirror with such a mirror surface

(76) Inventor: Thomas Rydqvist, Enskededalen (SE)

Correspondence Address: CONNOLLY BOVE LODGE & HUTZ LLP, SUITE 800, 1990 M STREET NW, WASHINGTON, DC, 20036-3425, US

(21) Appl. No.: 10/482,576

(22) PCT Filed: Jun. 19, 2002
(86) PCT No.: PCT/SE02/01189

(30) Foreign Application Priority Data
Jun. 26, 2001 (SE) 0102259-9

(51) Int. Cl. G02B 5/08; G02B 7/18

(52) U.S. Cl. 359/843

(57) ABSTRACT

In a method for achieving a required mirror surface on an aluminium workpiece (1), four different production steps (A, B, C, D) are used. In a first production step, an initial surface (1a) is produced by the aluminium workpiece undergoing one or more turning processes. During the turning process, the surface is produced with an exceptional turning precision. In a second en production step, the initial surface is hard-anodised in an electrolyte bath (6) to create an intermediate surface. The hard-anodising is carried out in such a way that an oxide layer of Al₂O₃ is formed on the turned initial surface. In a third production step, the hard-anodised intermediate surface is polished to prescribed polishing precision, and in a fourth production step, the polished surface is surface-coated with a material or substance in order to produce the required mirror surface. The invention also relates to a mirror or mirror surface and makes possible the production of low-weight mirrors/mirror surfaces with very good reflective properties.

The present invention relates to a method for achieving a required mirror surface on an aluminium workpiece, which mirror surface is produced in various production steps. In a first production step, an initial surface is achieved by the aluminium workpiece undergoing one or more turning processes at the position for the mirror surface. The invention also relates to a mirror arranged on an aluminium base or aluminium framework.

The use of various methods for producing mirrors and mirror surfaces is already known, and the use of mirrors and mirror surfaces with various constructions is also well known. In various connections, for example in connection with artillery equipment, gyros, sights, etc, there is a need to be able to use mirrors and mirror surfaces with extreme requirements regarding the mirror function as such, that is reflections, surface smoothness, etc. In connection with this, the use is known of for example diamond-turned surfaces and nickel-plated aluminium mirrors. In this connection, the use is also known of mirrors and mirror surfaces constructed of beryllium.

There are thus stringent requirements regarding properties of the mirrors/mirror surfaces in the areas of application stated above. The mirrors/mirror surfaces must be light or have a low weight in relation to the size of the surface area of the mirror surface and must in addition be able to fulfil stringent requirements concerning reflective properties, smoothness, surface fineness, small moments of inertia, etc. The object of the invention is to solve this problem, among others.

There is also a requirement that the use of the method for the production of the construction of mirrors/mirror surfaces is to be acceptable as far as the environment is concerned and it is to be noted in this respect that the use of beryllium has disadvantages on account of toxic material and the fact that the manufacture in such cases must be associated with special measures that prevent the spread of toxic material. The use of nickel-plated and/or diamond-turned mirrors means that several of the technical requirements mentioned above cannot be fulfilled. The invention also solves this problem.

Nor does the known technology fulfil the required demands for great mechanical durability and resistance to wear and tear, and the fact that the reflective coatings that are used must be able to be repaired or maintained in the event of pronounced wear and tear. The invention also solves this problem.

The main characteristics of the invention described by way of introduction is that, in the first production step, the turning process or processes are carried out on the initial surface with exceptional turning precision or smoothness, preferably a precision of approximately 30 micrometres or better (higher). Further characteristics are that, in a second production step, the aluminium workpiece is hard-anodised in an electrolyte bath on at least the part supporting the initial surface to create an intermediate surface. The hard-anodising is carried out in such a way that an oxide layer of Al₂O₃ is formed on the turned initial surface. In a third production step, the hard-anodised intermediate surface is polished in accordance with requirements that are prescribed or that are possible. Finally, the method is characterized in that, in a fourth production step, the polished intermediate surface is surface-coated with a reflective material or substance in order to produce the said required mirror surface.

Preferred embodiments of the new method are apparent from the subsequent subsidiary claims concerning the method in question.

The main characteristics of a mirror arranged on an aluminium base or framework are among other things that it comprises an initial surface located in or on the base and that it also comprises an oxide layer of Al₂O₃ arranged on the initial surface with exceptional surface finish and that the said oxide layer supports material or substance carrying out the reflective function.

Preferred embodiments of the new mirror or mirror surface are apparent from the subsequent subsidiary claims concerning the mirror in question.

By means of what is proposed above, a mirror arrangement is achieved that is mechanically durable and at the same time has very good functional properties and is relatively cheap to produce. The arrangement can be used on large base substrates and is characterized in particular by low weight, which is particularly advantageous in difficult terrain, for example for tanks, armoured vehicles and other cross-country units. The mirror arrangement can operate with exceptionally small forces of inertia, which results in a considerably increased application in the field. The aluminium workpiece can be provided with an exceptionally hard oxide layer of Al₂O₃, which consists of or forms sapphire.

Currently preferred embodiments of a method and a mirror (mirror surface) according to the invention will be described below with reference to the attached drawings in which

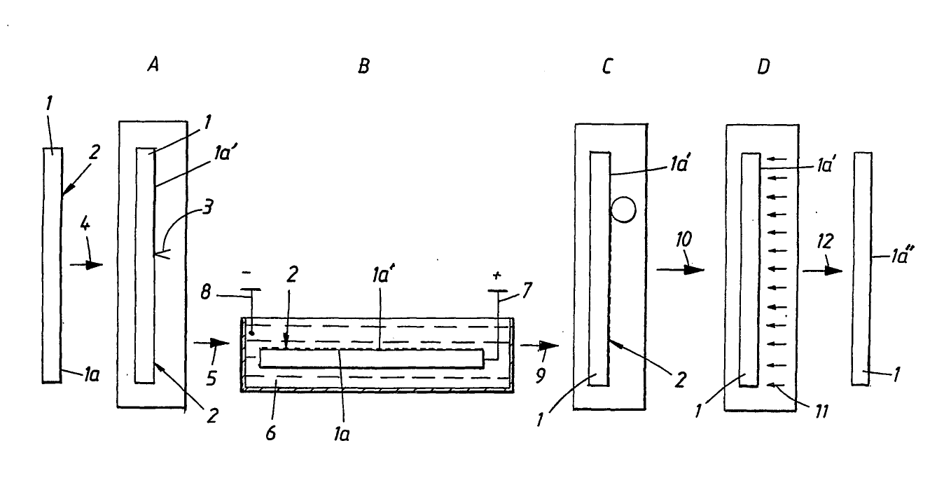

FIG. 1 is an explanatory sketch showing the method of production for a mirror or mirror surface with various production steps,

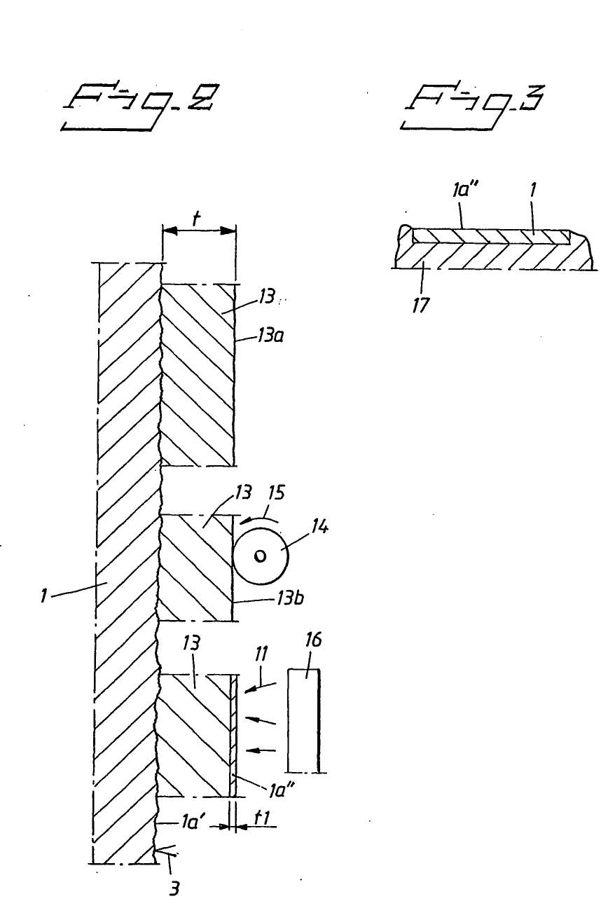

FIG. 2 shows in vertical section and greatly enlarged parts of an aluminium workpiece that is processed in a turning process and is provided with an oxide layer on the turned surface, a layer that is polished, and a layer where the polished surface is provided with reflective material, and

FIG. 3 shows in cross-section the application of the mirror/mirror surface on a substrate that in turn can be arranged on a tank or the like.

In FIG. 1 an aluminium workpiece is indicated by 1, which on one side 1ₐ is to be provided with a mirror surface 2. The workpiece 1 undergoes treatment in various production steps that are indicated for purposes of explanation by A, B, C and D. In the first processing step A, the workpiece 1 is brought into contact with turning devices that can be of a known type. The turning devices process one side 2 of the workpiece and in FIG. 1 the turning process has been partially completed and a turned surface 1a′ has started to be produced. The movement of the workpiece towards the workstation A has been symbolized by an arrow 4 that represents the movement in question. Turning can be carried out in a known way and is of such a type and design that a smoothness or flatness can be obtained that is better than approximately 30 micrometres.

After the workpiece 1 has undergone the said turning process, the workpiece is taken in the direction of the arrow 5 to a second workstation B that carries out a second production step. This production step is of the type that hard-anodises at least the part that supports the turned surface 1a′ so that a layer of Al₂O₃, described in greater detail in the following, is formed on the surface 1a′ in question. The hard-anodising that is carried out is to be carried out optimally in such a way that as thick an oxide layer as possible is obtained on the surface in question. In the present case, an electrolyte bath 6 is used that results in the layer in question having a thickness value of approximately 50 micrometres. As the hard-anodising and also the electrolyte bath are previously known technology, they will not be described in greater detail here, but it will only be stated that the aluminium workpiece is connected to a plus potential 7 and via the electrolyte bath 6 to a minus potential. The electrolyte bath is connected via a lead arrangement to a minus potential on a voltage source in question. The size of the voltage, currents, power, times, etc, are also known and will not be described here in greater detail. After the hard-anodising at the workstation B, the workpiece is taken in the direction of the arrow 9 to a workstation C, at which a third production step is carried out. The third production step comprises polishing the hard-anodised surface 1a′ of the aluminium workpiece 1. The polishing in question can be carried out in a known way and will therefore not be described here in greater detail. The polishing is carried out in such a way that a prescribed surface finish or flatness is achieved and it can be mentioned here that the flatness can be, for example, λ/2. The smoothness or surface fineness (RMS) is of the order of 10-20 Ångström, which corresponds to a well-polished glass mirror. After processing at the workstation C, the workpiece 1 is taken to the workstation D that carries out a fourth production step, in which the oxidised and polished surface 1a′ in question is coated with a substance or material that gives the surface a reflective character in a known way. The material or substance is represented in FIG. 1 by arrows 11. The coating with the material or substrate in question can be carried out in a known way, for example with increased Al or by dielectric means. The station D can operate as an evaporation plant for the application of the substrate or material in question. Workstation D operates in a way that is already known and that will not be described here in greater detail. When the workpiece 1 is removed from the workstation D in, for example, the direction of the arrow 12, there is thus a substrate 1 with finished surface 1a″ with the properties given above.

In FIG. 2, the parts of the workpiece according to FIG. 1 are also indicated by 1. As in FIG. 1, the turning function is indicated by 3 and the turned surface is indicated by 1a′ on the substrate. FIG. 2 shows the oxide layer 13 obtained at workstation B according to FIG. 1 in its different states that are obtained at the workstations B, C, and D. The thickness of the layer is indicated by t and can in accordance with the above assume values of preferably approximately 50 micrometres. The layer thickness t can, however, be lower if so required and a suitable range for the thickness t is considered to be between 30-50 micrometres. 13a indicates the outer surface of the oxide layer that is obtained in connection with the hard-anodising at workstation B. 13b indicates the surface that is obtained after the processing at the workstation C. In FIG. 2, the polishing function is indicated symbolically by 14. The polishing function can operate with a rotating element that rotates in the direction of the arrow 15. FIG. 2 also shows the layer 1a″ that is obtained in the fourth production step D, which carries out the application of the reflective material or the reflective substance. The thickness of the layer 1a″ is indicated by t1 and can be values of 10-20 Ångström . The arrangement for applying the substance or material 11 is indicated for purposes of explanation by 16 in FIG. 2. The finished workpiece 1 with the finished surface 1a″ is shown in FIG. 3, where the workpiece and the surface are arranged on or in an underlying substrate or an underlying unit 17. The unit 17 can in turn be applied in the area of use concerned, for example on a tank, gyro, etc. By means of the invention, an arrangement is obtained that is particularly advantageous as far as weight is concerned. In comparison with conventional methods and mirrors/mirror surfaces, a reduction of weight is obtained that means that the unit in question weighs only approximately 1/10 of mirrors/mirror surfaces that are produced by previously known conventional methods and constructions. Previously known reflective arrangements that probably weigh 400-500 kg can now be produced, for example, weighing 30-40 kg. The said hard-anodising can also be carried out only on parts of the surface in question 1a′ and/or can be of various thicknesses within a given range.

The invention is not limited to the embodiment described above by way of example, but can be modified within the framework of the subsequent claims and concept of the invention.

1. Method for achieving a required mirror surface on an aluminium workpiece, which mirror surface is produced in various production steps (A, B, C, D) and where, in a first production step (A), an initial surface is achieved by the aluminium workpiece undergoing one or more turning processes at the position for the said mirror surface, characterized in that, in the first production step (A), the turning process(es) produce an initial surface with exceptional turning precision (smoothness), preferably a precision of approximately 30 micrometres or better, that in a second production step (B), the aluminum workpiece is hard-anodised in an electrolyte bath on at least the part supporting the initial surface to create an intermediate surface, and that the hard-anodising is carried out in such a way that an oxide layer of Al₂O₃ is formed on the turned initial surface, that, in a third production step (C), the hard-anodised intermediate surface is polished to a prescribed or possible polishing precision (surface fineness), and that, in a fourth production step (D), the polished intermediate surface is surface-coated with a reflective material or substance in order to produce the required mirror surface.

2. Method according to claim 1, characterized in that the initial surface is hard-anodised optimally so that the layer created has values within a range from 30-50 micrometres, preferably values at the higher end of the range.

3. Method according to claim 1, characterized in that, in the third production step (C), the intermediate surface is given a smoothness of approximately λ/2 by means of the polishing.

4. Method according to claim 1, characterized in that, in the third production step (C), the intermediate surface is given a surface fineness of approximately 10-20 Angstrom by means of the polishing.

5. Method according to claim 1, characterized in that the reflective material or the reflective substance consists of aluminium that is applied by dielectric means.

6. Mirror (mirror surface) arranged on an aluminium base (aluminium framework), characterized in that it comprises an initial surface located on or in the base, that it also comprises an oxide layer of Al₂O₃ with exceptional surface finish arranged on the initial surface, and that the said oxide layer supports the reflective material or substance.

7. Mirror according to claim 6, characterized in that the oxide layer has a smoothness of approximately λ/2.

8. Mirror according to claim 6, characterized in that the oxide layer has a surface fineness of approximately 10-20 Angstrom .

9. Mirror according to claim 6, characterized in that the reflective material or substance comprises or consists of a layer of aluminium.

10. Mirror according to claim 6, characterized in that the mirror (mirror surface) and the aluminum workpiece form a low-weight unit in relation to the size of surface area of the mirror, for example a unit that has a weight that is a tenth of the weight of a conventionally manufactured mirror.

11. Method according to claim 2, characterized in that, in the third production step (C), the intermediate surface is given a smoothness of approximately λ/2 by means of the polishing.

12. Method according to claim 2 characterized in that, in the third production step (C), the intermediate surface is given a surface fineness of approximately 10-20 Angstrom by means of the polishing.

13. Method according to claim 3, characterized in that, in the third production step (C), the intermediate surface is given a surface fineness of approximately 10-20 Angstrom by means of the polishing.

14. Method according to claim 2, characterized in that the reflective material or the reflective substance consists of aluminium that is applied by dielectric means.

15. Method according to claim 3, characterized in that the reflective material or the reflective substance consists of aluminium that is applied by dielectric means.

16. Method according to claim 4, characterized in that the reflective material or the reflective substance consists of aluminium that is applied by dielectric means.

17. Mirror according to claim 7, characterized in that the oxide layer has a surface fineness of approximately 10-20 Angstrom.

18. Mirror according to claim 7, characterized in that the reflective material or substance comprises or consists of a layer of aluminium.

19. Mirror according to claim 8, characterized in that the reflective material or substance comprises or consists of a layer of aluminium.

20. Mirror according to claim 7, characterized in that the mirror (mirror surface) and the aluminum workpiece form a low-weight unit in relation to the size of surface area of the mirror, for example a unit that has a weight that is a tenth of the weight of a conventionally manufactured mirror.
